(19) United States
(12) Patent Application Publication
(10) Pub. No.: US 2016/0100158 A1
(43) Pub. Date: Apr. 7, 2016

(54) Display Device with Curved Display Function

(71) Applicant: Top Victory Investments Ltd., Kowloon (HK)

(72) Inventors: Hoover Chen, New Taipei City (TW); Tim Wu, New Taipei City (TW); Joseph Yang, New Taipei City (TW)

(21) Appl. No.: 14/507,920

(22) Filed: Oct. 7, 2014

(51) Int. Cl. H04N 13/04; G06K 9/00

(52) U.S. Cl. CPC H04N 13/0484; G06K 9/00228

(57) ABSTRACT

A display device includes a flat-panel screen, an image capturing module, an eye tracking module, a screen rotating and tilting module, a flat-to-curve emulation module, and a flat-to-curve mechanical module. The display device employs the flat-to-curve emulation module to transform a rectangular flat image displayed by the flat-panel screen to a pincushion-like flat image according to a user's eye position; therefore, it may automatically provide the “emulated” curved image according to the user's eye position so that a user may perceive a visual effect like seeing a curved image. The display device further employs the flat-to-curve mechanical module to bend the flat-panel screen into a curved screen according to the user's eye position to bend the flat image displayed by the flat-panel screen into a curved image; therefore, it may automatically provide the “real” curved image according to the user's eye position to enhance the visual effect.

### BACKGROUND OF THE INVENTION

1. Field of the Invention

The present invention relates to a display device and, more particularly, to a display device with a curved display function.

2. Description of the Related Art

A conventional flat-panel display device has a flat-panel screen for displaying a flat image. However, because a viewing distance between a user's eye position and a center of the flat-panel screen is different from that, for example, between the user's eye position and a left or right edge of the flat-panel screen, a user perceives an image distortion near the left or right edge of the flat image displayed by the flat-panel screen. As the size of the flat-panel screen gets larger and larger, the image distortion becomes more and more obvious and serious.

To improve the aforementioned problem, a curved display device has been developed recently. The curved display device has a curved screen for displaying a curved image. When the user's eye position is at the center of curvature of the curved screen, the viewing distance between the user's eye position and any horizontal position of the curved screen is constant; therefore, the user does not perceive any image distortion at any horizontal position of the curved screen, and the curved display device may provide the best visual effect for the user.

However, the curved display device has a fixed center of curvature; as a result, it limits viewing positions of the user. In addition, the user needs to change the viewing position according to the best viewing position of the display device to get the best visual effect, so that the curved display device is inconvenient in use.

### SUMMARY OF THE INVENTION

The present invention is adapted to providing a display device with a curved display function, which may automatically provide an “emulated” curved image or a “real” curved image according to a user's eye position.

According to an aspect of the present invention, there is provided a display device with a curved display function. The display device includes a flat-panel screen, an image capturing module, an eye tracking module, a screen rotating and tilting module, a flat-to-curve emulation module, and a flat-to-curve mechanical module. The flat-panel screen displays a flat image, and the flat-panel screen has a vertical height of H and a horizontal width of W. The image capturing module captures an environment image in front of the flat-panel screen. The eye tracking module determines a user's eye position according to the environment image. The screen rotating and tilting module automatically swivels and/or tilts the flat-panel screen according to the user's eye position so that a connecting line between a center of the flat-panel screen and the user's eye position is perpendicular to the flat-panel screen. The flat-to-curve emulation module transforms a first flat image displayed by the flat-panel screen to a second flat image according to the user's eye position, in which the first flat image is a rectangular flat image having the vertical height of H and the horizontal width of W, and the second flat image is a pincushion-like flat image having

$$h ( x ) = H \times \frac{\sqrt{{x}^{2} + {D}^{2}}}{\sqrt{{( \frac{W}{2} )}^{2} + {D}^{2}}} ,$$

where x is a horizontal distance relative to the center of the flat-panel screen, h(x) is a vertical height of the second flat image at a position whose horizontal distance relative to the center of the flat-panel screen is x, and D is a viewing distance between the user's eye position and the center of the flat-panel screen. The flat-to-curve mechanical module bends the flat-panel screen into a curved screen according to the user's eye position to bend the flat image displayed by the flat-panel screen into a curved image.

According to another aspect of the present invention, the display device further includes a pyroelectric infrared (PIR) sensor. The PIR sensor detects whether a person is in front of the flat-panel screen, and activates the eye tracking module when the PIR sensor detects a person in front of the flat-panel screen.

According to another aspect of the present invention, the flat-panel screen includes a liquid-crystal display (LCD) screen, an organic light-emitting diode (OLED) screen, or an e-paper screen.

According to another aspect of the present invention, the eye tracking module performs a human face recognition and then a pupil recognition based on the environment image to determine the user's eye position, and determines whether an image of a human face predetermined by the human face recognition is correct according to whether the human face moves within a preset time.

According to another aspect of the present invention, the eye tracking module further determines whether the image of the human face is correct according to whether there is blood flow in the detected human face.

According to another aspect of the present invention, the flat-to-curve mechanical module applies forces to a left side and a right side of the flat-panel screen in a hydraulic, pneumatic, or mechanical manner to bend the flat-panel screen into the curved screen.

According to another aspect of the present invention, the flat-to-curve mechanical module further determines whether the viewing distance is not less than (i.e. greater than or equal to) a minimum radius of curvature to which the flat-panel screen may be bent. When the viewing distance is not less than the minimum radius of curvature, the flat-to-curve mechanical module bends the flat-panel screen into the curved screen with the viewing distance as its radius of curvature.

According to another aspect of the present invention, when the viewing distance is less than the minimum radius of curvature, the display device performs one of the following operations.

(1) The flat-to-curve mechanical module does not bend the flat-panel screen, and sends an alert message.

(2) The flat-to-curve mechanical module bends the flat-panel screen into the curved screen with the minimum radius as its radius of curvature to bend the first flat image displayed by the flat-panel screen into a first curved image.

(3) The flat-to-curve emulation module transforms the first flat image displayed by the flat-panel screen to a third flat image having

$${h}^{′} ( x ) = H \times \frac{\sqrt{2 R \times ( R - D ) \times ( 1 - cos ( \frac{x}{R} ) ) + {D}^{2}}}{\sqrt{2 R \times ( R - D ) \times ( 1 - cos ( \frac{x}{2 R} ) ) + {D}^{2}}}$$

according to the viewing distance and the minimum radius of curvature, where x is a horizontal distance relative to the center of the flat-panel screen, h′(x) is a vertical height of the third flat image at a position whose horizontal distance relative to the center of the flat-panel screen is x, D is the viewing distance, and R is the minimum radius of curvature. Moreover, the flat-to-curve mechanical module bends the flat-panel screen into the curved screen with the minimum radius as its radius of curvature to bend the third flat image displayed by the flat-panel screen into a second curved image.

According to another aspect of the present invention, when there are multiple users' eye positions, the screen rotating and tilting module automatically swivels and/or tilts the flat-panel screen according to an average user's eye position of the multiple users' eye positions so that a connecting line between the center of the flat-panel screen and the average user's eye position is perpendicular to the flat-panel screen.

According to another aspect of the present invention, the flat-to-curve mechanical module bends the flat-panel screen into the curved screen according to the average user's eye position or a distribution of the multiple users' eye positions to bend the flat image displayed by the flat-panel screen into the curved image.

It is remarked that the above mentioned aspects or features can also be combined with each other and are in the scope of the present invention as well.

In sum, the present invention employs the flat-to-curve emulation module to transform the first flat image (i.e. a rectangular flat image) displayed by the flat-panel screen to the second flat image (i.e. a pincushion-like flat image) according to the user's eye position; therefore, it may automatically provide the “emulated” curved image (i.e. the second flat image) according to the user's eye position so that a user may perceive a visual effect like seeing a curved image. In addition, the present invention further employs the flat-to-curve mechanical module to bend the flat-panel screen into the curved screen according to the user's eye position to bend the flat image displayed by the flat-panel screen into the curved image; therefore, it may automatically provide the “real” curved image (i.e. the first or the second curved image) according to the user's eye position to enhance the visual effect.

### BRIEF DESCRIPTION OF THE DRAWINGS

The present invention will be described in further detail below under reference to the accompanying drawings, in which:

FIG. 1 shows a block diagram of a display device with a curved display function according to an exemplary embodiment of the present invention;

FIG. 2 shows (a) a front view and (b) a top view of the flat-panel screen shown in FIG. 1, displaying a first flat image;

FIG. 3 shows (a) a front view and (b) a top view of the flat-panel screen shown in FIG. 1, displaying a second flat image;

FIG. 4 shows (a) a front view and (b) a top view of a curved screen formed by bending the flat-panel screen shown in FIG. 1, displaying a first curved image;

FIG. 5 shows (a) a front view and (b) a top view of the flat-panel screen shown in FIG. 1, displaying a third flat image;

FIG. 6 shows (a) a front view and (b) a top view of a curved screen formed by bending the flat-panel screen shown in FIG. 5, displaying a second curved image;

FIG. 7 shows (a) a top view and (b) a side view of the flat-panel screen shown in FIG. 1, automatically adjusting according to one user's eye position;

FIG. 8 shows (a) a top view and (b) a side view of the flat-panel screen shown in FIG. 1, automatically adjusting according to multiple users' eye positions; and

FIG. 9 shows a top view of a curved screen formed by bending the flat-panel screen shown in FIG. 8 according to multiple users' eye positions.

### DETAILED DESCRIPTION OF THE INVENTION

Reference will now be made in detail to embodiments of the present invention that are illustrated in the accompanying drawings. Wherever possible, same or similar reference numerals are used in the drawings and the description to refer to the same or like parts. The drawings are in simplified form and are not to precise scale or shape. For purposes of convenience and clarity only, directional terms, such as left, right, front, rear, top, bottom, horizontal, and vertical may be used with respect to the drawings. These and similar directional terms should not be construed to limit the scope of the present invention in any manner.

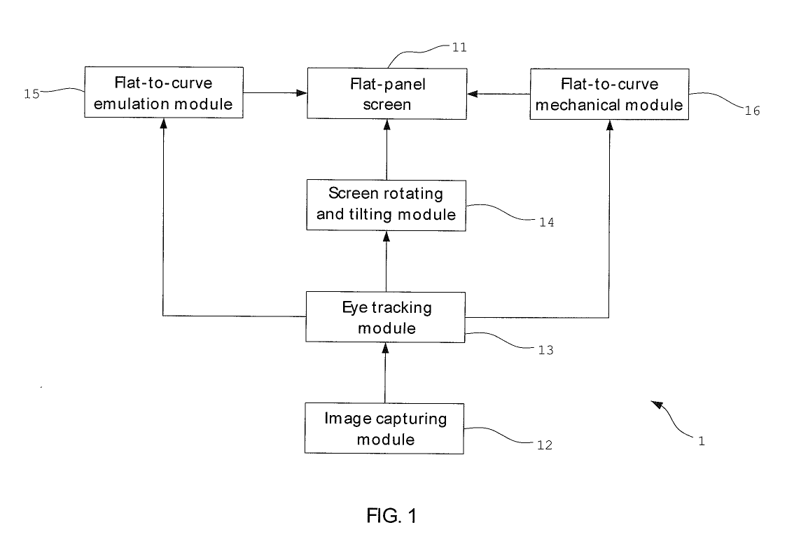

FIG. 1 shows a block diagram of a display device with a curved display function according to an exemplary embodiment of the present invention. Referring to FIG. 1, a display device 1 with a curved display function includes a flat-panel screen 11, an image capturing module 12, an eye tracking module 13, a screen rotating and tilting module 14, a flat-to-curve emulation module 15, and a flat-to-curve mechanical module 16. The eye tracking module 13 is electrically connected to the image capturing module 12. The screen rotating and tilting module 14 is electrically connected between the eye tracking module 13 and the flat-panel screen 11. The flat-to-curve emulation module 15 is electrically connected between the eye tracking module 13 and the flat-panel screen 11. The flat-to-curve mechanical module 16 is electrically connected between the eye tracking module 13 and the flat-panel screen 11.

The flat-panel screen 11 is used to display a flat image. The flat-panel screen 11 may be an LCD screen, an OLED screen, an e-paper screen, or another type of screen. The image capturing module 12 is used to capture an environment image in front of the flat-panel screen 11. The eye tracking module 13 is used to determine a user's eye position according to the environment image captured by the image capturing module 12. In an embodiment, the eye tracking module 13 may perform a human face recognition and then a pupil recognition based on the environment image to determine the user's eye position, and determine whether an image of a human face predetermined by the human face recognition is correct according to whether the human face moves within a preset time and/or whether there is blood flow in the detected human face. The screen rotating and tilting module 14 is used to automatically swivel and/or tilt the flat-panel screen 11 according to the user's eye position so that a connecting line between a center of the flat-panel screen 11 and the user's eye position is perpendicular to the flat-panel screen 11 (as discussed in more detail below).

The flat-to-curve emulation module 15 is used to transform a first flat image displayed by the flat-panel screen 11 to a second flat image according to the user's eye position. The first flat image is a rectangular flat image. The second flat image is a pincushion-like flat image generated by transforming the first flat image according to the user's eye position, and the pincushion-like flat image may make a user perceive a visual effect like seeing a curved image. The flat-to-curve mechanical module 16 is used to bend the flat-panel screen 11 into a curved screen according to the user's eye position to bend the flat image displayed by the flat-panel screen 11 into a curved image. The flat-to-curve mechanical module 16 may apply forces to a left side and a right side of the flat-panel screen 11 in a hydraulic, pneumatic, or mechanical manner to bend the flat-panel screen 11 into the curved screen.

In an embodiment, the display device 1 further includes a PIR sensor (not shown). The PIR sensor is used to detect whether a person is in front of the flat-panel screen 11. To save power, the PIR sensor activates the eye tracking module 13 only when the PIR sensor detects a person in front of the flat-panel screen 11.

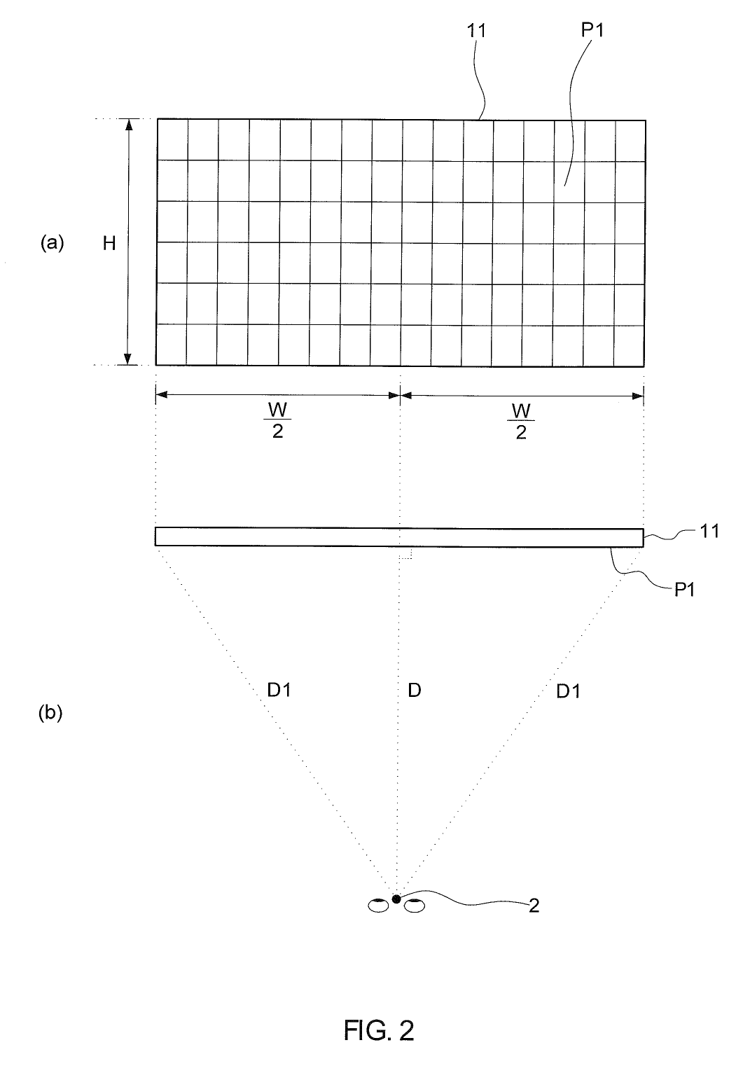

FIG. 2 shows (a) a front view and (b) a top view of the flat-panel screen 11 shown in FIG. 1, displaying a first flat image P1. Referring to FIGS. 1 and 2, as shown in (a) of FIG. 2, the flat-panel screen 11 has a vertical height of H and a horizontal width of W. The flat image displayed by the flat-panel screen 11 is the first flat image P1, and the first flat image P1 is a rectangular flat image having the vertical height of H and the horizontal width of W. In the embodiment, the first flat image P1 is illustrated like a regular graphing paper by vertical lines intersecting with horizontal lines.

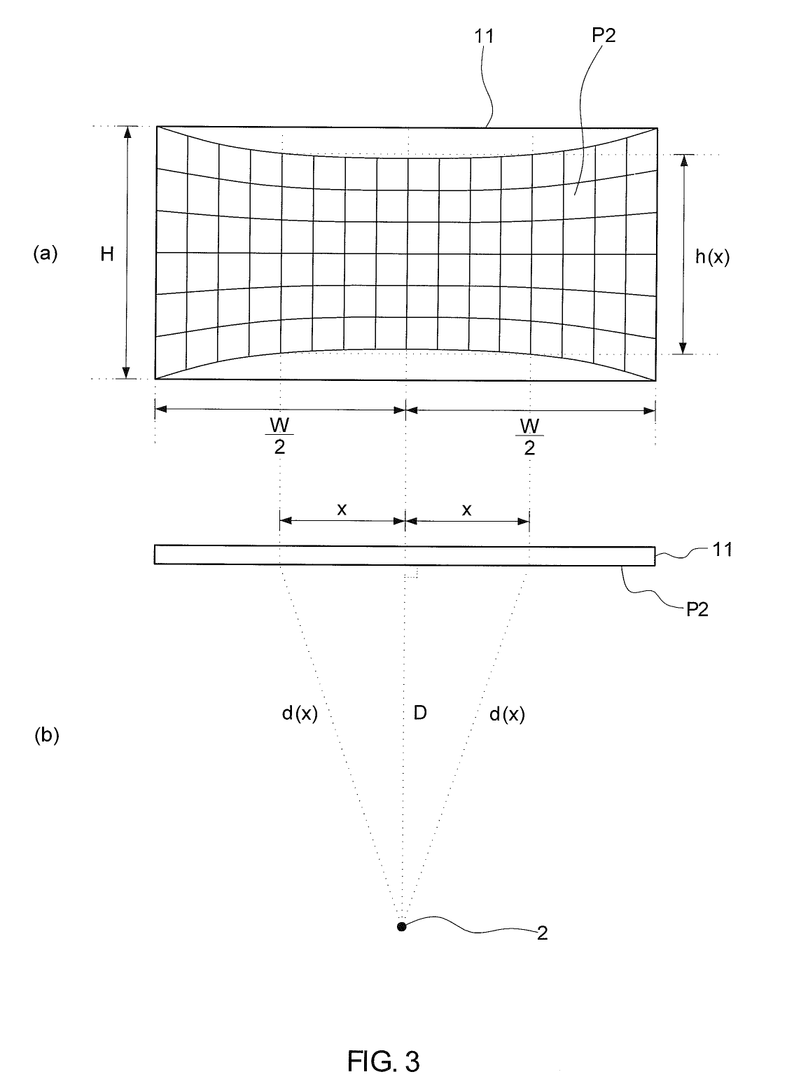

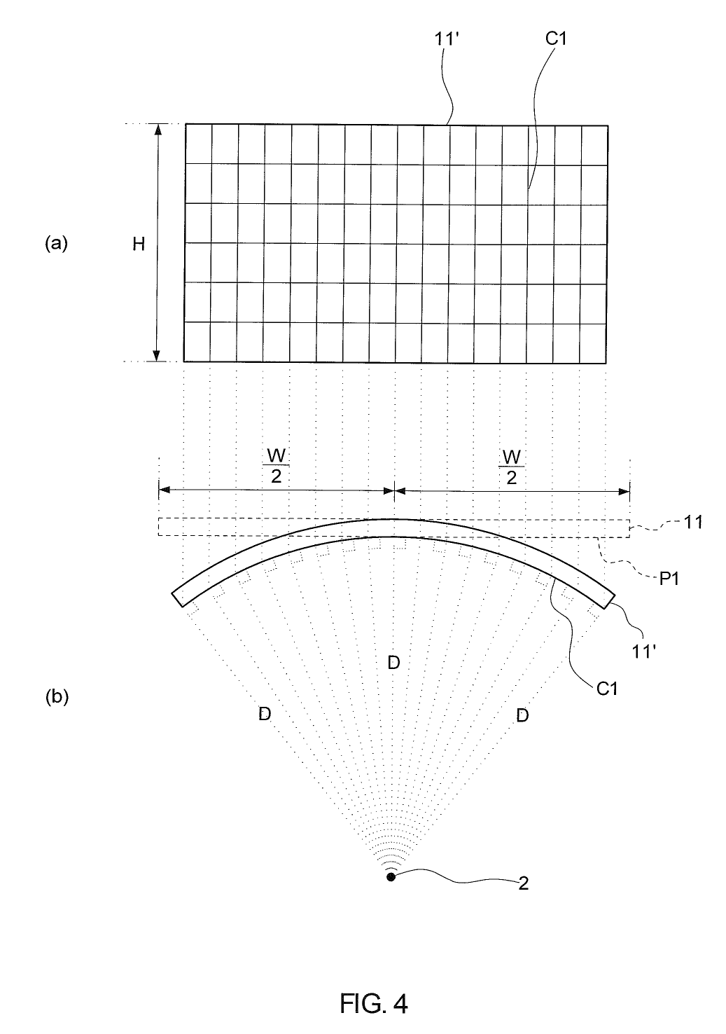

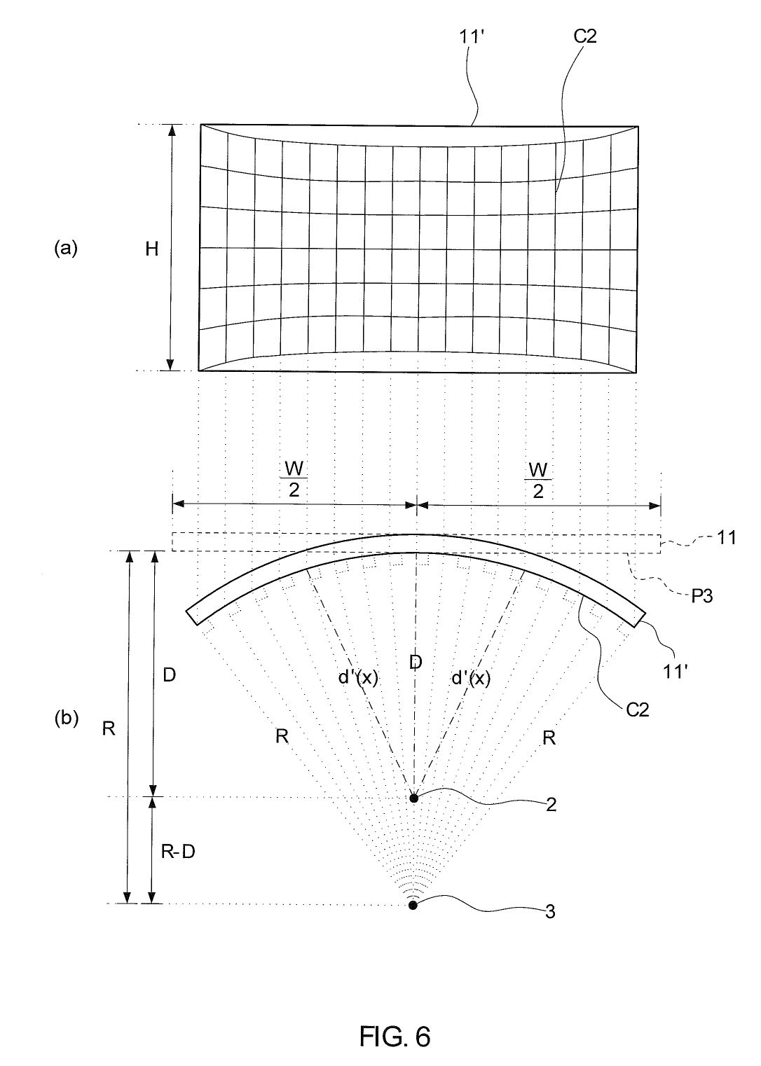

As shown in (b) of FIG. 2, the user's eye position 2 (expressed by a center point of pupils of two eyes) is right in front of the flat-panel screen 11. In other words, a connecting line between a center of the flat-panel screen 11 and the user's eye position 2 is perpendicular to the flat-panel screen 11. In the case, a viewing distance D between the user's eye position 2 and the center of the flat-panel screen 11 is different from another viewing distance D1 between the user's eye position 2 and the left or right edge of the flat-panel screen 11, so that the user perceives an image distortion near the left or right edge of the flat image displayed by the flat-panel screen 11. As the size of the flat-panel screen gets larger and larger, the image distortion becomes more and more obvious and serious. To improve the aforementioned problem to improve or enhance the visual effect, the display device 1 according to the embodiment of the present invention automatically provides a “emulated” curved image (e.g. a second flat image P2 shown in FIG. 3) or a “real” curved image (e.g. a first curved image C1 shown in FIG. 4, or a second curved image C2 shown in FIG. 6) according to the user's eye position 2.

FIG. 3 shows (a) a front view and (b) a top view of the flat-panel screen 11 shown in FIG. 1, displaying a second flat image P2. Referring to FIGS. 1 and 3, the flat-to-curve emulation module 15 transforms the first flat image P1 displayed by the flat-panel screen 11 to the second flat image P2 according to the user's eye position 2. It implies that, in the embodiment, the flat-to-curve emulation module 15 performs the transformation according to the viewing distance D between the user's eye position 2 and the center of the flat-panel screen 11. The first flat image P1 is a rectangular flat image having the vertical height of H and the horizontal width of W because the flat-panel screen 11 has the vertical height of H and the horizontal width of W. The second flat image P2 is a pincushion-like flat image having

$$h ( x ) = H \times \frac{d ( x )}{d ( \frac{W}{2} )} = H \times \frac{\sqrt{{x}^{2} + {D}^{2}}}{\sqrt{{( \frac{W}{2} )}^{2} + {D}^{2}}} ,$$

where x is a horizontal distance relative to the center of the flat-panel screen 11, h(x) is a vertical height of the second flat image P2 at a position whose horizontal distance relative to the center of the flat-panel screen 11 is x, H and W are the vertical height and the horizontal width of the flat-panel screen 11 respectively, D is the viewing distance between the user's eye position 2 and the center of the flat-panel screen 11, and d(x)=\sqrt{x²+D²} is the viewing distance between the user's eye position 2 and the position of the second flat image P2 whose horizontal distance relative to the center of the flat-panel screen 11 is x.

When x=0, d(0)=D, and

$$h ( 0 ) = H \times \frac{D}{\sqrt{{( \frac{W}{2} )}^{2} + {D}^{2}}} ,$$

where d(0) is the viewing distance between the user's eye position 2 and the position of the second flat image P2 whose horizontal distance relative to the center of the flat-panel screen 11 is x=0, and h(0) is the vertical height of the second flat image P2 at the position whose horizontal distance relative to the center of the flat-panel screen 11 is x=0. That is to say, d(0) is the viewing distance D shown in FIG. 2. When

$$x = \frac{W}{2} , d ( \frac{W}{2} ) = \sqrt{{( \frac{W}{2} )}^{2} + {D}^{2}} = D 1 , and$$

$$h ( \frac{W}{2} ) = H , where d ( \frac{W}{2} )$$

is the viewing distance between the user's eye position 2 and the position of the second flat image P2 whose horizontal distance relative to the center of the flat-panel screen 11 is

$$x = \frac{W}{2} , and h ( \frac{W}{2} )$$

is the vertical height of the second flat image P2 at the position whose horizontal distance relative to the center of the flat-panel screen 11 is

$$x = \frac{W}{2} .$$

That is to say,

$$d ( \frac{W}{2} )$$

is the viewing distance D1 shown in FIG. 2.

As shown in (a) of FIG. 3, compared to the first flat image P1, the horizontal lines of the second flat image P2 are bowed inwards, towards the center of the image so that the second flat image P2 is like a pincushion and called a pincushion-like flat image. The pincushion-like flat image or the second flat image P2 may make the user perceive a visual effect like seeing a curved image.

FIG. 4 shows (a) a front view and (b) a top view of a curved screen formed by bending the flat-panel screen 11 shown in FIG. 1, displaying a first curved image C1. Referring to FIGS. 1 and 4, when the flat-panel screen 11 displays the first flat image P1, the flat-to-curve mechanical module 16 bends the flat-panel screen 11 into a curved screen 11′ with the viewing distance D as its radius of curvature according to the user's eye position 2 (impliedly including the viewing distance D) to bend the flat image P1 displayed by the flat-panel screen 11 into the first curved image C1. In the case, the user's eye position 2 is at the center of curvature of the curved screen 11′ so that the viewing distance between the user's eye position 2 and any horizontal position of the curved screen 11′ is constant; therefore, the user does not perceive any image distortion at any horizontal position of the curved screen and perceives to be surrounded by video content when he or she sees the video, and the curved display device may provide the best visual effect for the user.

However, there exists a maximum curvature (or a minimum radius of curvature) to which the flat-panel screen 11 may be bent. When the flat-panel screen 11 is bent to exceed the maximum curvature, the curved screen formed by bending the flat-panel screen 11 will be broken soon or later. Therefore, before bending, the flat-to-curve mechanical module 16 further determines whether the viewing distance D is not less than the minimum radius of curvature to which the flat-panel screen 11 may be bent.

When it determines that the viewing distance D is not less than the minimum radius of curvature, it represents that the flat-panel screen 11 bent according to the viewing distance D will not exceed the maximum curvature. In the case, the flat-to-curve mechanical module 16 may bend, as shown in FIG. 4, the flat-panel screen 11 into the curved screen 11′ according to the viewing distance D, so that the curved screen 11′ has a radius of curvature which is equal to the viewing distance D.

When it determines that the viewing distance D is less than the minimum radius of curvature, it represents that the flat-panel screen 11 may not be bent, as shown in FIG. 4, into the curved screen 11′ with the viewing distance D as its radius of curvature because it will result in exceeding the maximum curvature to which the flat-panel screen 11 may be bent. In the case, the display device 1 performs one of the following operations.

(1) The flat-to-curve mechanical module 16 does not bend the flat-panel screen 11, and sends an alert message. The alert message may be an alert image, or an alert sound. For example, the flat-to-curve mechanical module 16 may control the flat-panel screen 11 to display the alert image, or control a loudspeaker (not shown) to play the alert sound.

(2) The flat-to-curve mechanical module 16 bends the flat-panel screen 11 into the curved screen with the minimum radius as its radius of curvature. It represents that the flat-panel screen 11 is just bent to the maximum curvature to which the flat-panel screen 11 may be bent. Thus, the flat-to-curve mechanical module 16 bends the first flat image P1 shown in FIG. 2 displayed by the flat-panel screen 11 into the first curved image Cl as shown in FIG. 4.

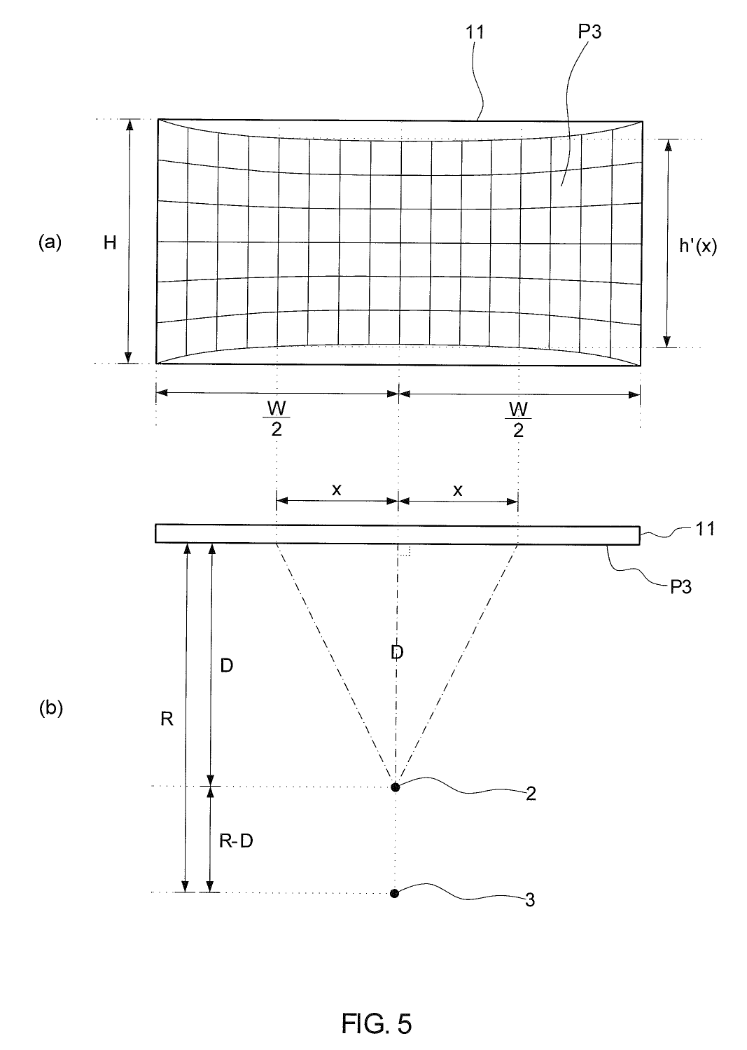

(3) As shown in FIG. 5, the flat-to-curve emulation module 15 transforms the first flat image P1 displayed by the flat-panel screen 11 to a third flat image P3 according to the viewing distance D and the minimum radius of curvature R to which the flat-panel screen 11 may be bent. Moreover, as shown in FIG. 6, the flat-to-curve mechanical module 16 bends the flat-panel screen 11 into the curved screen 11′ with the minimum radius R as its radius of curvature to bend the third flat image P3 displayed by the flat-panel screen 11 into a second curved image C2. The first flat image P1 is a rectangular flat image. The third flat image P3 is a pincushion-like flat image having

$${h}^{′} ( x ) = H \times \frac{{d}^{′} ( x )}{{d}^{′} ( \frac{W}{2} )} = H \times \frac{\sqrt{2 R \times ( R - D ) \times ( 1 - cos ( \frac{x}{R} ) ) + {D}^{2}}}{\sqrt{2 R \times ( R - D ) \times ( 1 - cos ( \frac{x}{2 R} ) ) + {D}^{2}}} ,$$

where x is a horizontal distance relative to the center of the flat-panel screen 11, h′(x) is a vertical height of the third flat image P3 at a position whose horizontal distance relative to the center of the flat-panel screen 11 is x, H and W are the vertical height and the horizontal width of the flat-panel screen 11 respectively, D is the viewing distance between the user's eye position 2 and the center of the flat-panel screen 11, and

$${d}^{′} ( x ) = \sqrt{2 R \times ( R - D ) \times ( 1 - cos ( \frac{x}{R} ) ) + {D}^{2}}$$

is the viewing distance between the user's eye position 2 and a position of the second curved image C2 corresponding to the position of the third flat image P3 whose horizontal distance relative to the center of the flat-panel screen 11 is x. In the case, although the user's eye position 2 is not at the center of curvature 3 of the curved screen 11′, it transforms the first flat image P1 to the third flat image P3 and bends the flat-panel screen 11 into the curved screen 11′ so that the user may perceive a visual effect like that at the center of curvature 3 of the curved screen 11′.

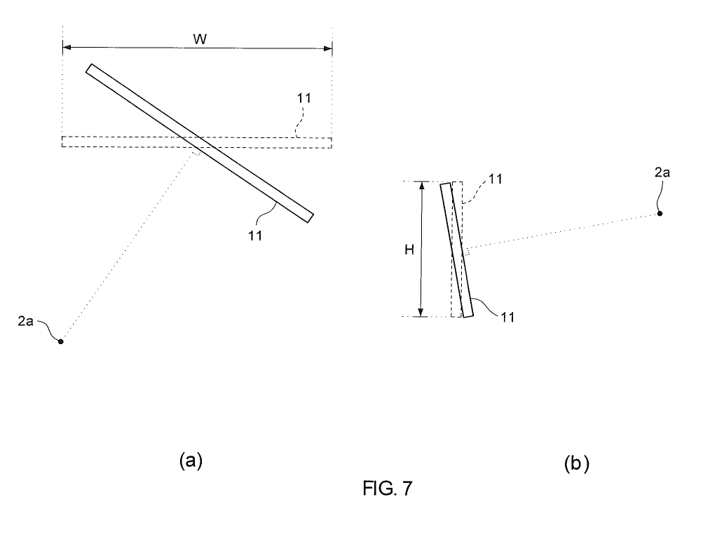

FIG. 7 shows (a) a top view and (b) a side view of the flat-panel screen 11 shown in FIG. 1, automatically adjusting according to one user's eye position. Referring to FIGS. 1 and 7, when a connecting line between the center of the flat-panel screen 11 and a user's eye position 2a is not perpendicular to the flat-panel screen 11 (see dashed lines in FIG. 7), it represents that the user's eye position 2a does not provide the best viewing angle for the user. In the case, even if the display device 1 employs the flat-to-curve emulation module 15 and/or the flat-to-curve mechanical module 16 to generate the second flat image P2, the first curved image C1, or the second curved image C2, the user does not perceive good visual effect.

Therefore, the display device 1 needs to employ the screen rotating and tilting module 14 to automatically swivel the flat-panel screen 11 as shown in (a) of FIG. 7, or tilt the flat-panel screen 11 as shown in (b) of FIG. 7, or swivel and tilt the flat-panel screen 11 as shown in (a) and (b) of FIG. 7 according to the user's eye position 2a so that the connecting line between the center of the flat-panel screen 11 and the user's eye position 2a is perpendicular to the flat-panel screen 11 (see dotted lines in FIG. 7). Then, the display device 1 may employ the flat-to-curve emulation module 15 and/or the flat-to-curve mechanical module 16 to generate the second flat image P2, the first curved image C1, or the second curved image C2 to provide or enhance the visual effect.

Although the aforementioned embodiments are adapted for one user, they are not intended to limit the scope of the present invention. The following embodiments are adapted for multiple users.

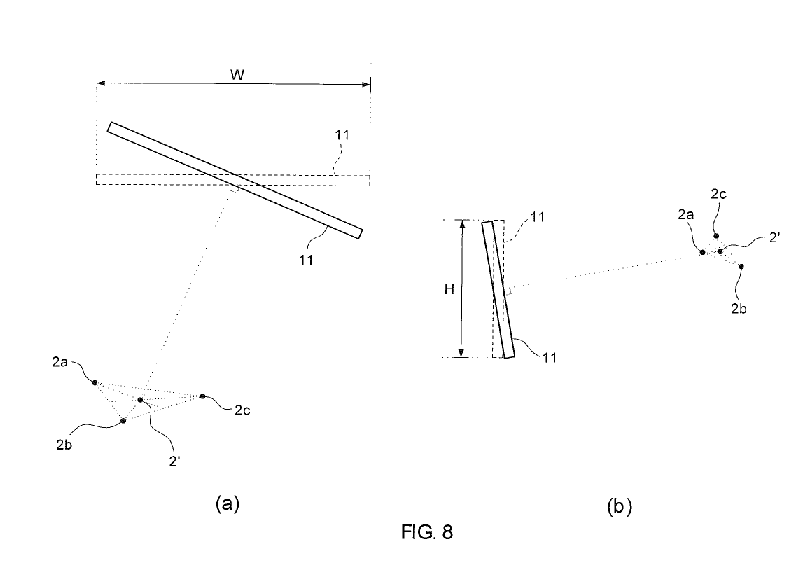

FIG. 8 shows (a) a top view and (b) a side view of the flat-panel screen 11 shown in FIG. 1, automatically adjusting according to multiple users' eye positions. Referring to FIGS. 1 and 8, when there are multiple users in front of the display device 1, the eye tracking module 13 determines that there are multiple users' eye positions 2a, 2b, and 2c according to the environment image. Then, the screen rotating and tilting module 14 automatically swivels the flat-panel screen 11 as shown in (a) of FIG. 8, or tilts the flat-panel screen 11 as shown in (b) of FIG. 8, or swivels and tilts the flat-panel screen 11 as shown in (a) and (b) of FIG. 8 according to an average user's eye position 2′ of the users' eye positions 2a, 2b, and 2c so that a connecting line between the center of the flat-panel screen 11 and the average user's eye position 2′ is perpendicular to the flat-panel screen 11.

In the embodiment, each of the users' eye positions 2a, 2b, and 2c has the same weight, so that the average user's eye position 2′ is a position obtained by an arithmetic mean. But the embodiment is not intended to limit the scope of the present invention. The average user's eye position may be a position obtained by a weighted mean. For example, the users' eye positions such as 2a and 2b are relatively close to each other, and are gathered into a group. A weight of any user's eye position of a group, such as the user's eye position 2a or 2b of the group of the users' eye positions 2a and 2b, is higher than that of single user's eye position such as 2c. In addition, a weight of any user's eye position of a group with more users is higher than that of another group with fewer users.

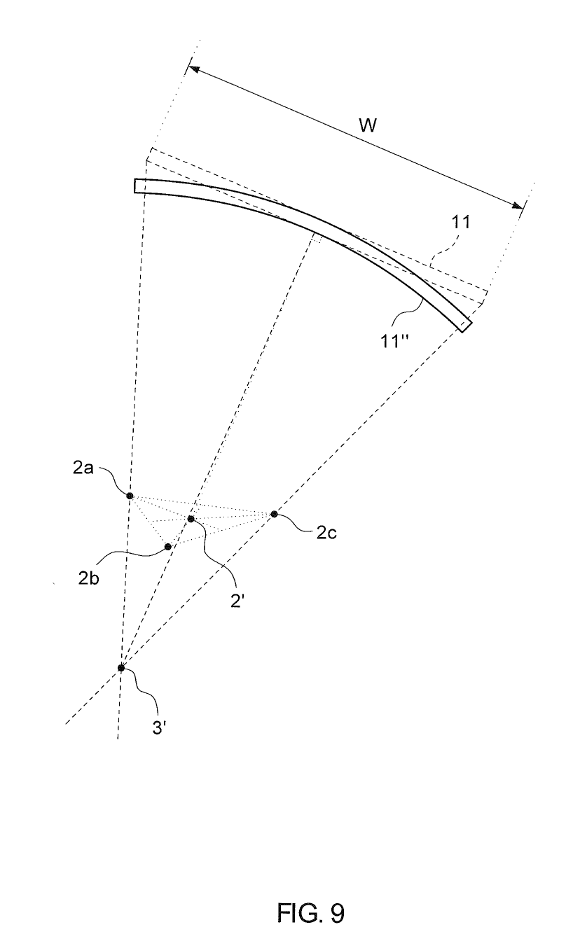

FIG. 9 shows a top view of a curved screen formed by bending the flat-panel screen 11 shown in FIG. 8 according to multiple users' eye positions. Referring to FIGS. 1 and 9, after the flat-panel screen 11 automatically adjusts to make the connecting line between the center of the flat-panel screen 11 and the average user's eye position 2′ be perpendicular to the flat-panel screen 11 as shown in FIG. 8, the flat-to-curve mechanical module 16 may bend the flat-panel screen 11 into a curved screen 11″ according to a distribution of the users' eye positions 2a, 2b, and 2c to bend the flat image displayed by the flat-panel screen 11 into the curved image. In the embodiment, a center of curvature 3′ is obtained by connecting the left and right edges of the flat-panel screen 11 with the outermost user's eye position 2a and 2c respectively, and then the flat-panel screen 11 is bent into the curved screen 11″ based on the center of curvature 3′.

As shown in FIG. 9, when the distribution of the users' eye positions is more divergent, the length of the radius of curvature increases, and the curvature of the curved screen decreases; otherwise, when the distribution of the users' eye positions is more convergent, the length of the radius of curvature decreases, and the curvature of the curved screen increases. If the distribution of the users' eye positions is too divergent to form the center of curvature 3′ in front of the flat-panel screen 11, the flat-panel screen 11 will not be bent and maintain a flat state. But the embodiment is not intended to limit the scope of the present invention. For example, the flat-to-curve mechanical module 16 may bend the flat-panel screen 11 into the curved screen with the average user's eye position 2′ as its center of curvature to bend the flat image displayed by the flat-panel screen 11 to the curved image.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A display device with a curved display function, comprising:
a flat-panel screen for displaying a flat image, the flat-panel screen having a vertical height of H and a horizontal width of W;
an image capturing module for capturing an environment image in front of the flat-panel screen;
an eye tracking module for determining a user's eye position according to the environment image;
a screen rotating and tilting module for automatically swiveling and/or tilting the flat-panel screen according to the user's eye position so that a connecting line between a center of the flat-panel screen and the user's eye position is perpendicular to the flat-panel screen;
a flat-to-curve emulation module for transforming a first flat image displayed by the flat-panel screen to a second flat image according to the user's eye position, wherein the first flat image is a rectangular flat image having the vertical height of H and the horizontal width of W, and the second flat image is a pincushion-like flat image having
$$h ( x ) = H \times \frac{\sqrt{{x}^{2} + {D}^{2}}}{\sqrt{{( \frac{W}{D} )}^{2} + {D}^{2}}} ,$$
wherein x is a horizontal distance relative to the center of the flat-panel screen, h(x) is a vertical height of the second flat image at a position whose horizontal distance relative to the center of the flat-panel screen is x, and D is a viewing distance between the user's eye position and the center of the flat-panel screen; and
a flat-to-curve mechanical module for bending the flat-panel screen into a curved screen according to the user's eye position to bend the flat image displayed by the flat-panel screen into a curved image.

2. The display device of claim 1, wherein the display device further comprises a pyroelectric infrared (PIR) sensor for detecting whether a person is in front of the flat-panel screen, and activating the eye tracking module when the PIR sensor detects a person in front of the flat-panel screen.

3. The display device of claim 1, wherein the flat-panel screen comprises a liquid-crystal display (LCD) screen, an organic light-emitting diode (OLED) screen, or an e-paper screen.

4. The display device of claim 1, wherein the eye tracking module performs a human face recognition and then a pupil recognition based on the environment image to determine the user's eye position, and determines whether an image of a human face predetermined by the human face recognition is correct according to whether the human face moves within a preset time.

5. The display device of claim 4, wherein the eye tracking module further determines whether the image of the human face is correct according to whether there is blood flow in the detected human face.

6. The display device of claim 2, wherein the eye tracking module performs a human face recognition and then a pupil recognition based on the environment image to determine the user's eye position, and determines whether an image of a human face predetermined by the human face recognition is correct according to whether the human face moves within a preset time.

7. The display device of claim 6, wherein the eye tracking module further determines whether the image of the human face is correct according to whether there is blood flow in the detected human face.

8. The display device of claim 1, wherein the flat-to-curve mechanical module applies forces to a left side and a right side of the flat-panel screen in a hydraulic, pneumatic, or mechanical manner to bend the flat-panel screen into the curved screen.

9. The display device of claim 1, wherein the flat-to-curve mechanical module further determines whether the viewing distance is not less than a minimum radius of curvature to which the flat-panel screen may be bent; when the viewing distance is not less than the minimum radius of curvature, the flat-to-curve mechanical module bends the flat-panel screen into the curved screen with the viewing distance as its radius of curvature.

10. The display device of claim 9, wherein when the viewing distance is less than the minimum radius of curvature, the display device performs one of the following operations:
(1) the flat-to-curve mechanical module does not bend the flat-panel screen, and sends an alert message;
(2) the flat-to-curve mechanical module bends the flat-panel screen into the curved screen with the minimum radius as its radius of curvature to bend the first flat image displayed by the flat-panel screen into a first curved image;
(3) the flat-to-curve emulation module transforms the first flat image displayed by the flat-panel screen to a third flat image having
$${h}^{′} ( x ) = H \times \frac{\sqrt{2 R \times ( R - D ) \times ( 1 - cos ( \frac{x}{R} ) ) + {D}^{2}}}{\sqrt{2 R \times ( R - D ) \times ( 1 - cos ( \frac{x}{2 R} ) ) + {D}^{2}}}$$
according to the viewing distance and the minimum radius of curvature, wherein x is a horizontal distance relative to the center of the flat-panel screen, h′(x) is a vertical height of the third flat image at a position whose horizontal distance relative to the center of the flat-panel screen is x, D is the viewing distance, and R is the minimum radius of curvature; moreover, the flat-to-curve mechanical module bends the flat-panel screen into the curved screen with the minimum radius as its radius of curvature to bend the third flat image displayed by the flat-panel screen into a second curved image.

11. The display device of claim 1, wherein when there are multiple users' eye positions, the screen rotating and tilting module automatically swivels and/or tilts the flat-panel screen according to an average user's eye position of the multiple users' eye positions so that a connecting line between the center of the flat-panel screen and the average user's eye position is perpendicular to the flat-panel screen

12. The display device of claim 11, wherein the flat-to-curve mechanical module bends the flat-panel screen into the curved screen according to the average user's eye position or a distribution of the multiple users' eye positions to bend the flat image displayed by the flat-panel screen into the curved image.
